(19) United States
(12) Patent Application Publication
(10) Pub. No.: US 2017/0201009 A1
(43) Pub. Date: Jul. 13, 2017

(54) MOBILE TERMINAL AND EXTERNAL ANTENNA

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Hao WU, Beijing (CN)

(21) Appl. No.: 15/242,494

(22) Filed: Aug. 20, 2016

Related U.S. Application Data
(63) Continuation of application No. PCT/CN2016/088644, filed on Jul. 5, 2016.

(30) Foreign Application Priority Data
Jan. 8, 2016 (CN) 201610012609X

(51) Int. Cl. H01Q 1/24; H01Q 1/36; H01Q 1/22; H01Q 21/00

(52) U.S. Cl. CPC H01Q 1/243; H01Q 21/00; H01Q 1/36; H01Q 1/2275; H01Q 1/2291

(57) ABSTRACT

Disclosed are a mobile terminal and an external antenna. The mobile terminal comprises: a USB port which comprises at least two connection terminals and enables, when a connector of an external device is plugged into the said USB port, that any one of idle contacts of the said USB port and the said external device remains electrically connected, wherein the said external device serves as a Wi-Fi antenna in accordance with an antenna solution of Multiple-Input and Multiple-Output; a data transmission module which comprises a data connection port which is connected to one of the connection terminals of the said USB port; and a radio frequency module which comprises at least two antenna connection ports, wherein any one of the said at least two antenna connection ports remains electrically connected to the said idle contacts.

### CROSS REFERENCE TO RELATED DISCLOSURES

The present application is a continuation of PCT application which has an application number of PCT/CN2016/088644 and was filed on Jul. 5, 2016. The present application claims the priority of a Chinese patent application titled “mobile terminal and external antenna”, which was filed with the Chinese Patent Office on Jan. 8, 2016 and has an application number of 201610012609.X, the contents of which are incorporated by reference herein in its entirety.

### TECHNICAL FIELD

The present application relates to the technological field of transmission and reception of signals, a mobile terminal and an external antenna in particular.

### BACKGROUND

Multiple-Input and Multiple-Output (MIMO) technology was introduced in the wake of 802.11n, a Wi-Fi standard. MIMO is a kind of abstract mathematical model which describes a wireless communication system of multiple antennas. Signals are transmitted independently by each of the antennas of a transmitter, multiple antennas of a receiver, in the meantime, receive signals and restore them to original information. MIMO can substantially increase data throughput and transmission distance of a system without increasing bandwidth or total loss of transmission power, so that it attracted much attention in recent years. However, in prior art of MIMO antenna schemes, a very large space inside a cell phone is required for accommodating multiple antennas of the receiver and transmitter. Space inside a cell phone is rather small; it is for this reason, and among others, that MIMO has not been adopted by cell phones, mobile terminals and the like.

In the wake of the increasing demand by users in recent years for access to online multimedia contents, a pressing need for MIMO becomes apparent that MIMO technology needs to be applied on mobile terminals such as cell phones. Many different antennas which perform various functions for cell phones exist in prior art, including, for example, a GPS antenna for realizing wireless voice call, a Wi-Fi antenna for realizing wireless connection to Internet and a Bluetooth antenna for realizing short distance transmission.

Among those antennas, GPS antennas comprise a primary antenna and at least one secondary antenna. When the primary antenna is in work, the secondary antenna must be not. In such occasion, the secondary antenna can be used, according to an antenna solution of MIMO technology, as the Wi-Fi antenna. It is often to use different secondary antennas of a cell phone as the Wi-Fi antenna time-division to implement a MIMO antenna solution so as to realize the Wi-Fi function, which is controlled by a software programme responsible for turning on and off different secondary antennas on demand. Although this way of implementation utilizes existing antennas inside a cell phone and no modification on hardware is required, more switches are needed and introduction of software switch controlling can be complex and also problematic that normal use of a cell phone, making a voice call, might be poorly affected under some complicated circumstances.

### SUMMARY

One objective of the present application is to provide a mobile terminal and an external antenna, both of which may improve the performance of wireless communication of a mobile terminal under circumstances of encountering weak signals.

According to an aspect of the present application, a mobile terminal is provided, comprising: a USB port which comprises at least two connection terminals and enables, when a connector of an external device is plugged into the said USB port, that any one of idle contacts of the said USB port remains electrically connected to the said external device, wherein the said external device serves as a Wi-Fi antenna in accordance with an antenna solution of MIMO; a data transmission module which comprises a data connection port which is connected to one of the connection terminals of the USB port; and a radio frequency module which comprises at least two antenna connection ports, wherein any one of the said at least two antenna connection ports remains electrically connected to the said idle contacts.

According to another aspect of the present application, an external antenna to be used in conjunction with the said mobile terminal is provided, wherein the said external antenna comprises a connector and an antenna unit, the said antenna unit, via the said connector, is plugged into a USB port of the said mobile terminal and is electrically connected to any one of idle contacts of the said USB port.

A technological solution of the present application provides that, provided that a connector of an external device is plugged into a USB port, the external device remains electrically connected to any one of idle contacts of the USB port. In this case, the said external device serves as a Wi-Fi antenna in accordance with an antenna solution of MIMO. Under circumstances of encountering weak signals, a MIMO antenna solution is realized by having that the said external antenna operates in conjunction with any internal antennas of a mobile terminal, for example a cell phone. In this way, the performance of wireless communication of a mobile terminal reaches optimal, so that better user experience is achieved.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a structural view of a mobile terminal in accordance with an embodiment of the present invention;

FIG. 2 is an illustrative view of a logic circuit of a mobile terminal in accordance with an embodiment of the present invention; and

FIG. 3 is a structural view of a housing of a mobile terminal in accordance with an embodiment of the present invention.

### DETAILED DESCRIPTION

Exemplary embodiments of the present application will be described in more detail below with reference to the figures. Although the figures illustrate exemplary embodiments of the present application, it should be appreciated that the present application may be implemented in various forms and should not be limited by embodiments herein. On the contrary, these embodiments provide for complete understanding of the present application, and are sought to fully convey the scope of this application to those skilled in the art.

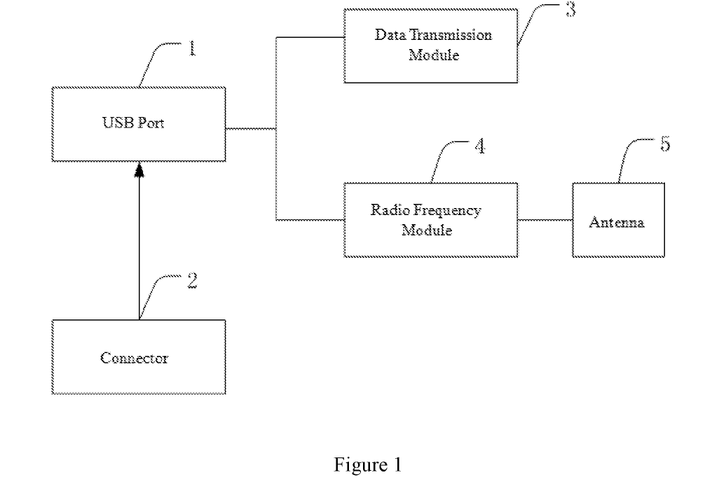

FIG. 1 is a structural view of a mobile terminal in accordance with an embodiment of the present invention. As shown in FIG. 1, the said mobile terminal comprises a USB port 1, a data transmission module 3 and a radio frequency module 4.

The USB port 1 which comprises at least a first connection terminal 11 and a second connection terminal 12 and enables, when a connector 2 of an external device is plugged into the said USB port 1, that the said external device remains electrically connected to any one of idle contacts of the said USB port 1, wherein the said external device serves as a Wi-Fi antenna in accordance with an antenna solution of Multiple-Input and Multiple-Output (MIMO). For example, the said external device can be a data cable or an antenna or the like, which comprises the said connector 2.

In the present embodiment, the first connection terminal 11 is a data pin, and the second connection terminal 12 is an idle high speed pin. Correspondingly, the connector 2 comprises a fifth connection terminal and a sixth connection terminal. The fifth connection terminal is a data pin, and the sixth connection terminal is an idle high speed pin.

In an optional embodiment, the USB port 1 further comprises a third connection terminal 13 and a fourth connection terminal 14, wherein the third connection terminal 13 is a ground pin, and the fourth connection terminal 14 is a power supply pin. Correspondingly, the connector 2 further comprises a seventh connection terminal and an eighth connection terminal, wherein the seventh connection terminal is a ground pin, and the eighth connection terminal is a power supply pin.

The data transmission module 3 comprises a data connection port which is connected to the first connection terminal 11 of the USB port 1.

In the present embodiment, the data transmission module 3 can output data through the said USB port 1, or receive data signals through the said USB port 1. For example, when a data cable is plugged into the USB port 1, data signals, which for example can be a document file or the like, can be input into or received from the data cable by the data transmission module 3.

The radio frequency module 4 comprises a plurality of antenna connection ports, wherein a first antenna connection port 41 is connected to the second connection terminal 12 of the USB port 1, and the radio frequency module 4 may be used in conjunction with a matched antenna. When the radio frequency module 4 is connected to a matched antenna, the radio frequency module 4 may work in conjunction with the antenna to transmit and receive radio frequency signals.

According to a technological solution provided by the present application, an external antenna is connected to a radio frequency module via an idle contact of a USB port; when the external antenna which matches the radio frequency module is plugged into the USB port, the external antenna is electrically connected to the radio frequency module via the idle contact of the USB port, and the external antenna works in conjunction with the radio frequency module to transmit and receive radio frequency signals. Under circumstances of encountering weak signals, a MIMO antenna solution is realized by having that the said external antenna operates in conjunction with an internal antenna of a mobile terminal, for example a cell phone. In this way, the performance of wireless communication of a mobile terminal reaches optimal, so that better user experience is achieved.

In one embodiment, as shown in FIG. 1, the mobile terminal according to the present disclosure further comprises an antenna 5. The antenna 5 is connected to the second antenna connection port 42 of the said radio frequency module 4. The antenna 5 can work in conjunction with the radio frequency module 4 to transmit and receive radio frequency signals. Provided that an external antenna which is capable of matching the radio frequency module is plugged into the USB port, both the external antenna and the antenna 5 are connected to the radio frequency module. In this way, a MIMO antenna solution is realized, and the performance of wireless communication of the mobile terminal of this embodiment reaches optimal.

The radio frequency module 4 comprises a plurality of radio frequency circuits, and the antenna 5 comprises a plurality of antennas. When a Wi-Fi antenna is plugged into the USB port 1, the external Wi-Fi antenna can work in conjunction with the Wi-Fi radio frequency circuit of the radio frequency module 4 to transmit and receive signals, and the external Wi-Fi antenna can work in conjunction with the Wi-Fi antenna, which is connected to the second antenna connection port of the radio frequency module 4, to implement a MIMO antenna solution.

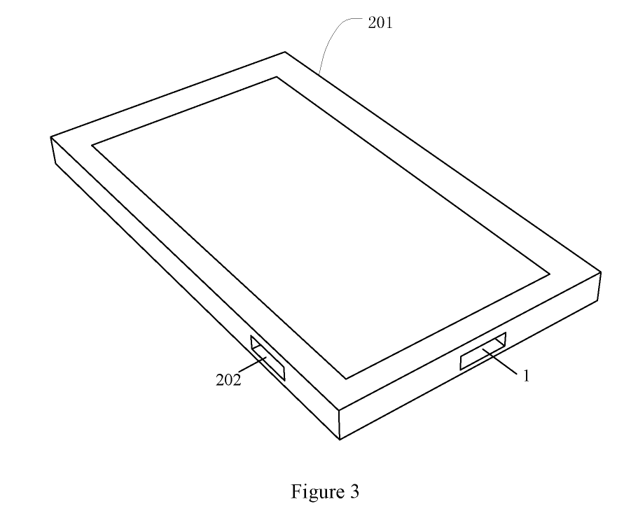

In one optional embodiment of the present application, as shown in FIG. 3, the mobile terminal according to an embodiment of the present application further comprises a housing 201 which has a receiving space (not marked in the figure), the said USB port 1, the said data transmission module 3 and the said radio frequency module 4 are all disposed in the said receiving space, the said housing 201 is provided with an opening by which the said USB port 1 is exposed, and the outer surface of the said housing 201 is provided with a receiving hole 202 for receiving an external device. In an embodiment, an external antenna which matches the radio frequency module 4 can be received in the receiving hole 202. The external antenna is only taken out from the receiving hole 202 when the need for use rises. It makes the external antenna easy for carrying and difficult to have it lost.

In one optional embodiment of the present application, the receiving hole 202 may be a blind hole or through hole, which can be configured according to users' actual requirements.

In embodiments, a mobile terminal according to embodiments of the present application can be a cell phone, a laptop, a tablet or the like, which can be configured according to users' actual requirements.

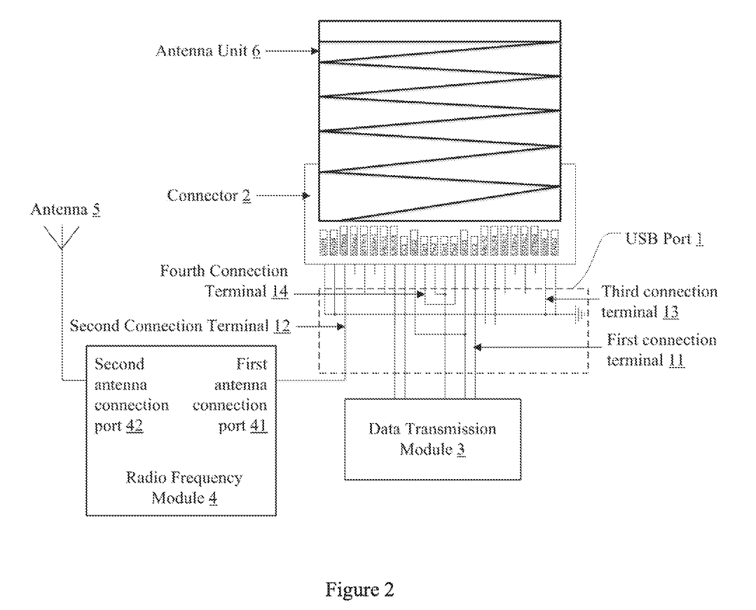

As shown in FIG. 2, an embodiment of the present disclosure further provides an external antenna to be used in conjunction with the said mobile terminal. The mobile terminal comprises a USB port, a data transmission module and a radio frequency module, wherein the USB port comprises at least two connection terminals, which are to receive a connector of an external device and keep electrically connected to the said external device; a data transmission module comprising a data connection port which is connected to a first connection terminal of the USB port; and a radio frequency module comprising a plurality of antenna connection ports, wherein a first antenna connection port is connected to a second connection terminal of the USB port.

As shown in FIG. 2, the external antenna comprises a connector 2 and an antenna unit 6, the external antenna, via the connector 2, is plugged into the USB port 1 of a mobile terminal, and remains electrically connected to the mobile terminal.

In an embodiment, as shown in FIG. 2, the antenna unit 6 comprises a feed conductor and a radiation assembly, the left end (i.e. one end) of the feed conductor is electrically connected to a connection terminal of the connector 2, and the right end (i.e. the other end) of the feed conductor is electrically connected to the radiation assembly. The radiation assembly is of a spiral shape.

In an embodiment, when the external antenna, via the connector 2, is plugged into the USB port 1 of the said mobile terminal, the external antenna remains electrically connected to the radio frequency module 4 via the second connection terminal of the connector 2 and the second connection terminal of the USB port 1, and the external antenna can work in conjunction with the radio frequency module 4 to transmit and receive radio frequency signals.

It has to be appreciated that the mobile terminal associated with the present embodiment may employ a mobile terminal structure as described in the above embodiments. Reference may be made to corresponding contents in the above embodiments for implementation and working principles which are omitted here.

The external antenna provided by embodiments of the present disclosure relatively operates in a flexible fashion. It, when not in use, can be seen as an accessory of a mobile terminal such as a cell phone, and it only, very conveniently, needs to be plugged in when needed. Furthermore, the external antenna may substantially boost wireless performance of a mobile terminal such as a cell phone under circumstances of encountering weak signals, and speed up Wi-Fi access to internet. Furthermore, design of external antennas can easily be standardized so as to be free from risks of impact from developments of mobile terminals such as a cell phone.

Embodiments according to the present application are described above, but these embodiments do not provide everything in detail, and none of which should limit the present disclosure. Obviously, many modifications and variations can be made according to the above depictions. In the description, these embodiments are selected and described in detail to better illustrate principles and actual application of the present application so that those skilled in the art can use the present application very well and make any modification on the basis of the present application. The present application is only limited by the claim set and all scope and equivalents thereof.

1-10. (canceled)

11. A mobile terminal, comprising:
a USB port which comprises at least two connection terminals and enables, when a connector of an external device is plugged into the said USB port, that any one of idle contacts of the said USB port remains electrically connected to the said external device, wherein the said external device serves as a Wi-Fi antenna in accordance with an antenna solution of Multiple-Input and Multiple-Output;
a data transmission module which comprises a data connection port which is connected to one of the connection terminals of the said USB port; and
a radio frequency module which comprises at least two antenna connection ports, wherein any one of the said at least two antenna connection ports remains electrically connected to the said idle contacts.

12. The mobile terminal according to claim 11, wherein the said mobile terminal further comprises the said external device which is an external Wi-Fi antenna.

13. The mobile terminal according to claim 12, wherein the said external Wi-Fi antenna comprises a connector and an antenna unit, the said antenna unit, via the said connector, is plugged into the said USB port and remains electrically connected to any one of idle contacts of the said USB port.

14. The mobile terminal according to claim 13, wherein the said antenna unit comprises a feed conductor and a radiation assembly, one end of the said feed conductor is electrically connected to a connection terminal of the said connector, and the other end of the said feed conductor is electrically connected to the radiation assembly.

15. The mobile terminal according to claim 14, wherein the said radiation assembly is of a spiral shape.

16. The mobile terminal according to claim 11, wherein the said mobile terminal further comprises:
a Wi-Fi antenna which is connected to another antenna connection port of the said radio frequency module, wherein the said Wi-Fi antenna serves as another Wi-Fi antenna in accordance with the antenna solution of Multiple-Input and Multiple-Output.

17. The mobile terminal according to claim 12, wherein the said mobile terminal further comprises:
a Wi-Fi antenna which is connected to another antenna connection port of the said radio frequency module, wherein the said Wi-Fi antenna serves as another Wi-Fi antenna in accordance with the antenna solution of Multiple-Input and Multiple-Output.

18. The mobile terminal according to claim 13, wherein the said mobile terminal further comprises:
a Wi-Fi antenna which is connected to another antenna connection port of the said radio frequency module, wherein the said Wi-Fi antenna serves as another Wi-Fi antenna in accordance with the antenna solution of Multiple-Input and Multiple-Output.

19. The mobile terminal according to claim 14, wherein the said mobile terminal further comprises:
a Wi-Fi antenna which is connected to another antenna connection port of the said radio frequency module, wherein the said Wi-Fi antenna serves as another Wi-Fi antenna in accordance with the antenna solution of Multiple-Input and Multiple-Output.

20. The mobile terminal according to claim 15, wherein the said mobile terminal further comprises:
a Wi-Fi antenna which is connected to another antenna connection port of the said radio frequency module, wherein the said Wi-Fi antenna serves as another Wi-Fi antenna in accordance with the antenna solution of Multiple-Input and Multiple-Output.

21. The mobile terminal according to claim 10, wherein the said mobile terminal further comprises a housing which has a receiving space, the said USB port, the said data transmission module and the said radio frequency module are all disposed in the said receiving space, the said housing is provided with an opening by which the said USB port is exposed, and the outer surface of the said housing is provided with a receiving hole for receiving an external device.

22. The mobile terminal according to claim 12, wherein the said mobile terminal further comprises a housing which has a receiving space, the said USB port, the said data transmission module and the said radio frequency module are all disposed in the said receiving space, the said housing is provided with an opening by which the said USB port is exposed, and the outer surface of the said housing is provided with a receiving hole for receiving an external device.

23. The mobile terminal according to claim 13, wherein the said mobile terminal further comprises a housing which has a receiving space, the said USB port, the said data transmission module and the said radio frequency module are all disposed in the said receiving space, the said housing is provided with an opening by which the said USB port is exposed, and the outer surface of the said housing is provided with a receiving hole for receiving an external device.

24. The mobile terminal according to claim 14, wherein the said mobile terminal further comprises a housing which has a receiving space, the said USB port, the said data transmission module and the said radio frequency module are all disposed in the said receiving space, the said housing is provided with an opening by which the said USB port is exposed, and the outer surface of the said housing is provided with a receiving hole for receiving an external device.

25. The mobile terminal according to claim 15, wherein the said mobile terminal further comprises a housing which has a receiving space, the said USB port, the said data transmission module and the said radio frequency module are all disposed in the said receiving space, the said housing is provided with an opening by which the said USB port is exposed, and the outer surface of the said housing is provided with a receiving hole for receiving an external device.

26. An external antenna, wherein the said external antenna is used in conjunction with a mobile terminal, wherein the said external antenna comprises a connector and an antenna unit, the said antenna unit, via the said connector, is plugged into the said USB port of the said mobile terminal and remains electrically connected to any one of idle contacts of the said USB port;
wherein the said mobile terminal comprises:
a USB port which comprises at least two connection terminals and enables, when a connector of an external device is plugged into the said USB port, that any one of idle contacts of the said USB port remains electrically connected to the said external device, wherein the said external device serves as a Wi-Fi antenna in accordance with an antenna solution of Multiple-Input and Multiple-Output;
a data transmission module which comprises a data connection port which is connected to one of the connection terminals of the said USB port; and
a radio frequency module which comprises at least two antenna connection ports, wherein any one of the said at least two antenna connection ports remains electrically connected to the said idle contacts.

27. The external antenna according to claim 26, wherein the said antenna unit comprises a feed conductor and a radiation assembly, one end of the said feed conductor is electrically connected to a first connection terminal of the said connector, and the other end of the said feed conductor is electrically connected to the radiation assembly.

28. The external antenna according to claim 27, wherein the said radiation assembly is of a spiral shape.
